(19) United States
(12) Patent Application Publication
(10) Pub. No.: US 2026/0268664 A1
(43) Pub. Date: Sep. 10, 2026

(54) CONTENT GENERATION METHOD, ELECTRONIC DEVICE, COMPUTER-READABLE STORAGE MEDIUM, AND PRODUCT

(71) Applicant: Beijing Zitiao Network Technology Co., Ltd., Beijing (CN)

(72) Inventors: Hui SUN, Beijing (CN); Rong ZOU, Beijing (CN)

(21) Appl. No.: 19/548,293

(22) Filed: Feb. 24, 2026

(30) Foreign Application Priority Data
Mar. 7, 2025 (CN) 202510272151.0

(51) Int. Cl. G06V 20/40; G06T 11/60; G06V 20/70; G06V 40/20

(52) U.S. Cl. CPC G06V 20/41; G06T 11/60; G06V 20/70; G06V 40/20

(57) ABSTRACT

The present disclosure relates to a content generation method, an electronic device, a computer-readable storage medium and a product, and relates to the field of computer technologies. The content generation method includes: determining an entity and a background in a first image from a first user; determining first information expressed by the first image by understanding the first image; expanding the first information based on the entity and the background in the first image to generate second information; generating one or move second images based on the second information; and generating first multimedia content based on the first image and the one or more second images.

### CROSS-REFERENCE TO RELATED APPLICATIONS

The present disclosure is based on and claims the benefit of Chinese Patent Application No. 202510272151.0, filed on March 7, 2025, the disclosure of which is hereby incorporated into this disclosure by reference in its entirety.

### TECHNICAL FIELD

The present disclosure relates to the field of computer technologies, and in particular, to a content generation method, an electronic device, a computer-readable storage medium, and a product.

### BACKGROUND

With the development of artificial intelligence technologies, a user may send content generation instructions using functions provided by various applications. Then, a computer automatically generates various types of content such as text, images, and videos based on the instructions. This process may be implemented using a machine learning model, such as a neural network model such as a large language model (abbreviated as LLM) or a foundation model, to use the powerful computing power of the model to meet various needs of the user.

### SUMMARY

According to some embodiments of the present disclosure, a content generation method is provided, including: determining an entity and a background in a first image from a first user; determine first information expressed by the first image by understanding the first image; expanding the first information based on the entity and the background in the first image to generate a second information; generating one or more second images based on the second information; and generating first multimedia content based on the first image and the one or more second images.

According to some embodiments of the present disclosure, an electronic device is provided, including: at least one memory; and at least one processor coupled to the at least one memory, the at least one processor configured to, based on instructions stored in the at least one memory, carry out the method of any of the embodiments described in the present disclosure.

According to some embodiments of the present disclosure, a non-transitory computer-readable storage medium is provided, having a computer program stored thereon, which, when executed by a processor, executes the method of any of the embodiments described in the present disclosure.

According to some embodiments of the present disclosure, a computer program product is provided, which, when running on a computer, causes the computer to execute the method of any of the embodiments described in the present disclosure.

Other features, aspects, and advantages of the present disclosure become apparent through the following detailed description of exemplary embodiments of the present disclosure with reference to the drawings.

### BRIEF DESCRIPTION OF THE DRAWINGS

Embodiments of the present disclosure are described below with reference to the drawings. It is to be understood that the drawings in the following description relate only to some embodiments of the present disclosure, but not to limit the present disclosure. In the drawings:

FIG. 1 is a schematic flowchart of a content generation method according to some embodiments of the present disclosure.

FIG. 2 is a schematic flowchart of generating a second information according to some embodiments of the present disclosure.

FIG. 3 is a schematic flowchart of generating a second image according to some embodiments of the present disclosure.

FIG. 4 is a schematic flowchart of generating second multimedia content according to some embodiments of the present disclosure.

FIG. 5 is a schematic diagram of a shooting interface according to some embodiments of the present disclosure.

FIG. 6 is a schematic diagram of first multimedia content according to some embodiments of the present disclosure.

FIG. 7 is a schematic diagram of a third image according to some embodiments of the present disclosure.

FIG. 8 is a schematic diagram of second multimedia content according to some embodiments of the present disclosure.

FIG. 9 is a schematic structural diagram of a content generation apparatus according to some embodiments of the present disclosure.

FIG. 10 is a block diagram of an electronic device according to some embodiments of the present disclosure.

FIG. 11 is a block diagram of an electronic device according to some other embodiments of the present disclosure.

It is to be understood that, for ease of description, the dimensions of the various parts shown in the drawings are not necessarily drawn to scale.

### DETAILED DESCRIPTION OF EMBODIMENTS

The technical solutions in the embodiments of the present disclosure are described clearly and completely below with reference to the drawings in the embodiments of the present disclosure. It is to be understood that the present disclosure may be implemented in various forms, and should not be construed as limited to the embodiments set forth herein.

It is to be understood that the various steps recited in the method implementations of the present disclosure may be performed in a different order and/or in parallel. In addition, the method implementations may include additional steps and/or omit performing the illustrated steps. The scope of the present disclosure is not limited in this respect. Unless otherwise specifically stated, the relative arrangements, numerical expressions, and numerical values of the components and steps set forth in these embodiments are to be construed as merely exemplary, and do not limit the scope of the present disclosure.

The term "include/comprise" and its variants used in the present disclosure are open-ended terms that mean "include/comprise at least the following element/feature, but do not exclude other elements/features", that is, "include/comprise but not limited to". The term "based on" means "at least partially based on".

It is to be noted that the concepts such as "first" and "second" mentioned in the present disclosure are merely used to distinguish between different apparatuses, modules, or units, and are not used to limit the order of functions performed by these apparatuses, modules, or units or interdependence therebetween. Unless otherwise specified, the concepts such as "first" and "second" are not intended to imply that the objects so described must be in a given order in terms of time, space, ranking, or any other manner.

It is to be noted that the modifiers "one" and "a plurality of" mentioned in the present disclosure are illustrative and not restrictive, and those skilled in the art should understand that unless otherwise clearly indicated in the context, the modifiers should be construed as "one or more".

The embodiments of the present disclosure are described in detail below with reference to the drawings, but the present disclosure is not limited to these specific embodiments. The following specific embodiments may be combined with each other, and the same or similar concepts or processes may not be described in detail in some embodiments. In addition, in one or more embodiments, a particular feature, structure, or characteristic may be combined in any suitable manner that will be clear to those of ordinary skill in the art from the present disclosure.

Some applications provide users with various interaction manners based on content generation technologies. For example, an image is generated based on a text provided by a user, a new image is generated based on an image provided by the user, or a video is generated based on an image provided by the user. These interaction manners satisfy the content generation needs of the user to some extent.

However, these current interaction manners require deep participation of the user and are low in intelligence. For example, when a new image is generated based on an image provided by the user, the user needs to indicate how to generate the new image. In addition, the content generated in these interaction manners is relatively low in richness and is not highly interesting. As a result, the role of content generation technologies is not fully played, and it is not conducive to the enthusiasm of the user to participate in interaction.

Based on this, the present disclosure provides a content generation method. The present disclosure is capable of automatically generating multimedia content with information based on an image provided by a user. That is, information is automatically generated based on the image provided by the user, and the multimedia content is generated based on the information. The intelligence of content generation technologies is fully utilized in the generation process of the multimedia content, and the information and the multimedia content may be automatically generated without the need for the user to provide too much information. This not only improves the richness of the generated content, but also improves the interaction experience of the user, thereby enhancing the enthusiasm of the user to participate in interaction and improving the usage rate of applications.

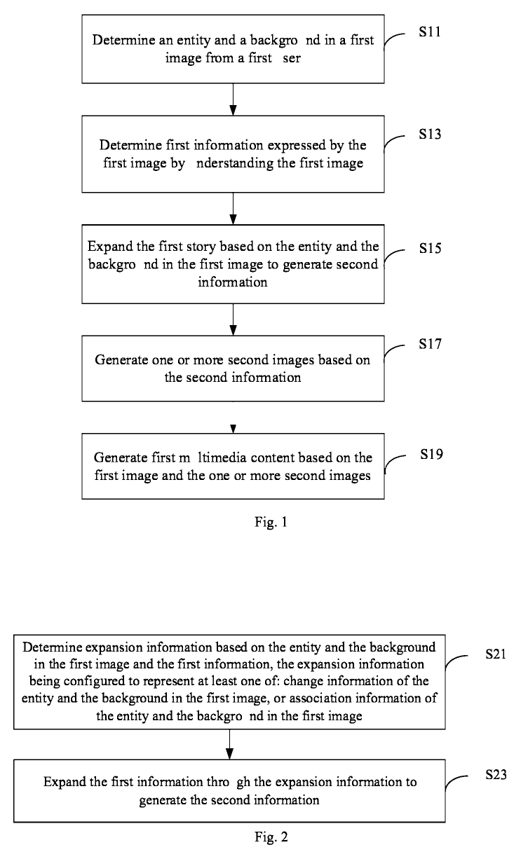

FIG. 1 is a schematic flowchart of a content generation method according to some embodiments of the present disclosure. As shown in FIG. 1, the content generation method includes steps S11 to S19.

In step S11, an entity and a background in a first image from a first user are determined.

The first image of the first user is acquired, and content generation is performed based on the first image. The first image may be an image of various styles and types, and may be a color image, a grayscale image, or the like.

The entity in the first image refers to a main object of expression in the first image, which is used to reflect a theme or emphasis that the first image intends to express. The entity may be any visual object, including a person, an object, or the like. The background in the first image refers to an environment or a foil around the entity, which is used to reflect an atmosphere of the first image, thereby making image content richer and more layered.

The entity in the first image may be determined using a target recognition algorithm. Alternatively, image processing technologies may also be used to divide foreground and background in the first image, and extract the entity from the foreground, etc. After the entity in the first image is determined, other objects than the entity in the first image are determined as the background.

Determining the entity and the background in the first image makes it possible to determine objects in the first image and the relationship between the objects. Generating content based on the objects in the first image and the relationship between the objects may improve the correlation between the generated content and the first image, that is, generating content around the first image, thereby improving the accuracy of the generated content.

In step S13, first information expressed by the first image is determined by understanding the first image.

The information expressed by an image can be information with a plot. For example, the information can be a story.

Understanding the first image includes performing target detection and recognition, scene understanding, semantic analysis, etc. on the first image, to determine the first information expressed by the first image. For example, when the first image shows a girl standing by a road and there is a sign of a bus station on the roadside, the first information expressed by the first image is that the girl is waiting for a bus. The first information can be a first story.

The first image is understood and the first information expressed by the first image is determined, so that content may be generated based on the information expressed by the first image, that is, content generation is performed around the first information. This may improve the accuracy of the generated content.

In step S15, the first information is expanded based on the entity and the background in the first image to generate a second information.

After the entity and the background included in the first image and the first information expressed by the first image are determined, the first information is expanded to generate the second information. The second information is generated, for example, by continuing, adapting, or supplementing the first information. This process is performed based on the entity and the background in the first image. For example, when the first image shows a girl standing by a road and there is a sign of a bus station on the roadside, the main body of the first image is the girl, the background is the sign of the bus station, and the first information is that the girl is waiting for a bus, the second information generated based on the girl and the sign of the bus station may be that the girl is sitting in a bus seat and listening to music. The second information can be a second story.

The first information is expanded based on the entity and the background in the first image, so that a person or an object appearing in the generated second information is associated with the entity and the background in the first image, thereby enabling the second information to be a reasonable expansion of the first information.

In step S17, one or more second images are generated based on the second information.

Before the second image is generated, information such as the number and style of the second image may be determined first.

In some embodiments, the number of the generated second images may be determined based on the richness of the second information. The higher the richness of the second information, the greater the number of the generated second images; the lower the richness of the second information, the smaller the number of the generated second images.

In some embodiments, the style of the generated second image may be determined based on the story style of the second information. For example, when the style of the second information is warm and touching, the style of the second image is also made warm and touching by setting the color, light and shadow, composition, etc. of the second image. The style of information can be a story style.

Since the second information is expanded from the first information, the one or more second images generated based on the second information are associated with the first image. In this way, the one or more second images associated with the first image are generated based on the first image provided by the first user, and the one or more second images correspond to the second information, so that the one or more second images with the information are generated for the first image of the first user.

In step S19, first multimedia content is generated based on the first image and the one or more second images.

After the one or more second images with the information are generated for the first image, the first multimedia content may be generated by combining the first image and the one or more second images.

When the second information is a continuation of the first information, for example, the first image and the one or more second images are sequentially displayed to generate the first multimedia content, so that the first multimedia content corresponds to the first information and the second information representing the subsequent development of the first information.

When the second information is an expansion, an adaptation, a supplement, etc. of the first information, for example, the first image and the one or more second images are cross-displayed to generate the first multimedia content, that is, the information corresponding to the first multimedia content is determined based on the relationship between the first information and the second information.

In addition to the first image and the one or more second images, the first multimedia content may further include content in other forms than images, such as text and audio. The text and audio may be determined based on the second information, so that the content in various forms in the first multimedia content is unified with each other.

The first multimedia content is generated by generating the second information based on the first image of the first user and then based on the second information. Therefore, the first multimedia content is multimedia content with a corresponding information, and the first multimedia content is richer in content and more interesting.

In the above embodiment, the first multimedia content with the corresponding information may be automatically generated based on the first image of the first user. This content generation method is capable of automatically generating information based on an image and then automatically generating multimedia content based on the information. Therefore, this content generation method is more intelligent, and the generated content is richer in content, which helps to improve the enthusiasm of user interaction, thereby improving the usage rate of applications.

FIG. 2 is a schematic flowchart of generating a second information according to some embodiments of the present disclosure. As shown in FIG. 2, the generating the second information includes steps S21 to S23.

In step S21, expansion information is determined based on the entity and the background in the first image and the first information, the expansion information being configured to represent at least one of: change information of the entity and the background in the first image, or association information of the entity and the background in the first image.

The expansion information is used to generate the second information. That is, in addition to generating the second information, the expansion information is determined by analyzing the entity and the background in the first image and the first information, starting from the first image, and then the second information is generated based on the expansion information.

The change information of the entity and the background in the first image is determined by changing the state, action, environment, etc. of the entity and the background in the first image. For example, when the entity in the first image includes a person, the change information of the person may be the change information of the action or expression of the person.

The change information of the entity and the background in the first image may be determined based on the entity or the background itself, or may be determined based on the relationship between the entity and the background. For example, when the entity in the first image includes a person, the change information of the person is the change information of the action. That is, the change information of the entity may be determined based on the entity itself. When the entity in the first image includes a person, the background includes an environment, and the environment is rainy, it is determined that the change information of the expression of the person is sad. When the entity in the first image includes a person, the background includes an environment, and the environment is a clear sky, it is determined that the change information of the expression of the person is happy. That is, the change information of the entity may be determined based on the entity and the background. Similarly, the change information of the background may be determined based on the background itself, or may be determined based on the entity and the background.

The association information of the entity and the background in the first image is determined by associating the entity with the background in the first image. For example, when the entity in the first image includes potato chips, the association information of the potato chips may be a convenience store. Because convenience stores tend to sell products such as potato chips.

The association information of the entity and the background in the first image may also be determined based on the entity or the background itself, or may be determined based on the relationship between the entity and the background. For example, when the entity in the first image includes potato chips, the association information of the potato chips is a convenience store. That is, the association information of the entity may be determined based on the entity itself. When the entity in the first image includes potato chips and the background includes a computer that is playing a video, the association information of the potato chips is juice. That is, the association of the entity may be determined based on the entity and the background. Similarly, the association information of the background may be determined based on the background itself, or may be determined based on the entity and the background.

The expansion information includes at least one of the change information of the entity and the background in the first image or the association information of the entity and the background in the first image. After the expansion information is determined, the expansion direction and elements of the first information are also determined, so that the second information may be generated.

In step S23, the first information is expanded through the expansion information to generate the second information.

After the expansion information is determined, the second information may be generated by integrating the change information of the entity and the background in the first image and the association information of the entity and the background in the first image included in the expansion information.

Since the emotional tone is an important component of the information, especially in a story, in some embodiments, the emotion included in the first image may be determined first, and then the second information may be generated by combining the emotion included in the first image. For example, expanding the first information based on the entity and the background in the first image to generate the second information includes: determining an emotion included in the first image based on the entity and the background in the first image; and expanding the first information based on the emotion included in the first image and the entity and the background in the first image to generate the second information.

The emotion included in the first image affects the expansion result of the first information. For example, when the emotion included in the first image is sadness, the emotional tone of the generated second information is also sad. In this way, the first multimedia content generated subsequently based on the second information is matched with the first image, which may increase the probability of the user's satisfaction with the generated content.

The emotion included in the first image may be determined based on the entity and the background in the first image. For example, when the entity in the first image includes a person, the emotion of the person may be determined based on the action, expression, etc. of the person. At the same time, the emotion included in the first image is determined by combining the emotion of the person with the environment, atmosphere, etc. of the background in the first image.

When the first information is expanded based on the emotion included in the first image, it may be performed as follows: determining the change information of the entity and the background in the first image based on the emotion; and expanding the first information based on the emotion and the change information of the entity and the background in the first image to generate the second information.

That is, the change information of the entity and the background in the first image is determined based on the emotion included in the first image. For example, when the entity in the first image includes a person and the emotion included in the first image is sadness, the change information of the person may be the change information of the expression of the person, for example, the expression of the person changes to crying. At the same time, the change information of the background may be the change information of the atmosphere, for example, the hue of the background becomes dark.

In some embodiments, determining the change information of the entity and the background in the first image based on the emotion includes: determining, in response to the entity in the first image including a character, change information of at least one of an action or an expression of the character based on the emotion; or determining, in response to the entity in the first image including an object, change information of a form of the object based on the emotion; or determining change information of at least one of an environment or an atmosphere of the background in the first image based on the emotion.

The character may be a person or an anthropomorphic object. The form of the object may be the appearance or display mode of the object. The environment and atmosphere may be controlled by setting objects in the background, the color of the background, etc.

In addition to determining the change information of the entity and the background in the first image based on the emotion included in the first image, the association information of the entity and the background in the first image may also be determined based on the emotion included in the first image. That is: determining the association information of the entity and the background in the first image based on the emotion; and expanding the first information based on the emotion and the association information of the entity and the background in the first image to generate the second information.

That is, the expansion information is determined based on the emotion included in the first image, and then the first information is expanded based on the expansion information to generate the second information. Determining the expansion information based on the emotion may improve the consistency between the change information of the entity and the background of the first image and the association information of the entity and the background of the first image in the expansion information, and reduce the risk of content confusion of the expansion information caused by inconsistent change directions of different entities and the background in the first image and inconsistent association directions of different entities and the background in the first image.

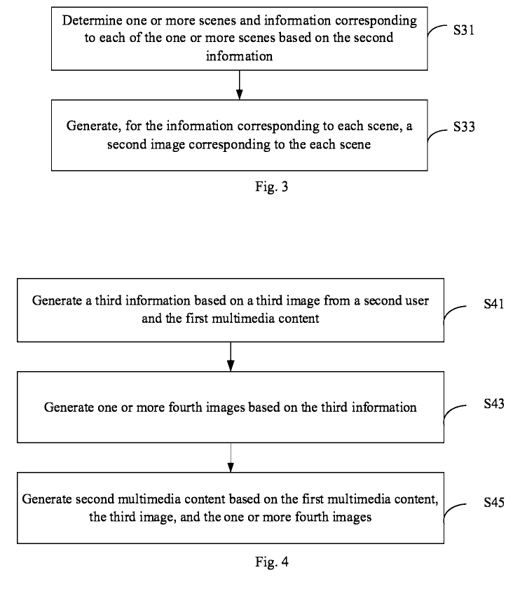

After the second information is generated, the one or more second images are generated based on the second information. Since the second information often takes place or is reflected in one or more scenes, the second image may be generated based on the scene of the second information. FIG. 3 is a schematic flowchart of generating a second image according to some embodiments of the present disclosure. As shown in FIG. 3, the generating the second image includes steps S31 to S33.

In step S31, one or more scenes and information corresponding to each of the one or more scenes are determined based on the second information.

When the one or more scenes and the information corresponding to each of the one or more scenes are determined based on the second information, it may be determined after sorting out and summarizing the second information. In this way, the key information in the second information is determined through the one or more scenes. The key information is the information corresponding to the scene. Generating the second image based on the key information may improve the integrity and accuracy of the generated second image in terms of reflecting the second information. The key information is, for example, key story.

In addition, when a plurality of second images are generated, the style of the second images may be unified. The unified style here means that the style is the same or the transition of the style is smooth. The style is usually reflected by emotion. Since the second image is generated based on the first image, the style of the second image may be determined based on the emotion included in the first image. Alternatively, since the second image corresponds to the second information, the style of the second image may also be determined based on the emotion included in the second information. That is, the style of the one or more second images is determined based on the emotion included in at least one of the second information or the first image; and the one or more second images are generated based on the style of the one or more second images. The style of the second image may be reflected, for example, by setting the filter, composition, color, light and shadow, etc. of the second image.

In step S33, for the information corresponding to each scene, a second image corresponding to the each scene is generated.

The second image corresponding to the scene is generated for each scene. The second image generated in this way may accurately reflect the second information.

After the one or more second images that may accurately reflect the second information and have a reasonable style are generated, the first multimedia content may be generated by combining the first image with the one or more second images. In addition to the first image and the one or more second images, the first multimedia content may further include content in the form of text, audio, etc. For example, a subtitle may be generated for each image in the first multimedia content. This not only enriches the first multimedia content, but also improves the expressiveness of the first multimedia content with corresponding information, and improves the interestingness.

In some embodiments, generating the first multimedia content based on the first image and the one or more second images includes: determining a subtitle of each image of the first image and the one or more second images, the subtitle of the each image being generated based on the information corresponding to the each image; and generating the first multimedia content based on the first image and the one or more second images, each image in the first multimedia content having a subtitle.

The first multimedia content may be presented as an image or a video. That is, the first multimedia content is an image, where the first multimedia content includes a plurality of images that may be switched and displayed, or an image formed by concatenating a plurality of images; or the first multimedia content is a video.

The plurality of images that may be switched and displayed are equivalent to a collection of images. The switching display of the plurality of images may be triggered in response to a user or a condition, for example, the current image is switched to the next image after being displayed for a specified duration. Concatenating a plurality of images refers to cropping or scaling the plurality of images to form the plurality of images into one image.

In some embodiments, the first multimedia content includes a plurality of images that may be switched and displayed, and the images in the plurality of images may be images formed by concatenating a plurality of images. That is, the first multimedia content may include a plurality of images that are formed by concatenating a plurality of images and may be switched and displayed.

Whether the first multimedia content is specifically presented as an image or a video may be determined based on the emotional intensity of the second information. That is, the first multimedia content is a video in response to the emotional intensity of the second information being greater than a first specified threshold; and the first multimedia content is an image in response to the emotional intensity of the second information being not greater than the first specified threshold. For example, when the second information is similar to a micro movie, the emotional intensity is relatively high, and it is more appropriate to present the first multimedia content as a video. When the second information is similar to a travel note, the emotional intensity is relatively low, and it is more appropriate to present the first multimedia content as an image.

Further, in response to the first multimedia content being an image, it may be determined whether the first multimedia content includes a plurality of images that may be switched and displayed or an image formed by concatenating a plurality of images.

Since concatenating a plurality of images involves the display effect of the images, whether to concatenate the plurality of images may be determined based on the image ratio of the images. In some embodiments, the first multimedia content includes an image formed by concatenating the plurality of images in response to the image ratio of the first image and the one or more second images being within a specified range.

Alternatively, whether to concatenate the plurality of images may be determined based on whether the images may be cropped. When determining whether the images may be cropped, it is usually determined based on the influence degree of cropping on the entity in the images. In a case where the influence degree of cropping on the entity in the images being relatively large, for example, when the main information of the entity cannot be displayed, the images are not cropped, and the first multimedia content is formed by switching and displaying the images. In a case where the influence degree of cropping on the entity in the images is relatively small, the images may be cropped to form the first multimedia content by concatenating the plurality of images.

In some embodiments, generating the first multimedia content based on the first image and the one or more second images includes: determining the influence degree of a specified cropping ratio on the entity in each of the first image and the one or more second images; determining, in response to the influence degree being less than a second specified threshold, an image formed by concatenating the first image and the one or more second images as the first multimedia content; and determining, in response to the influence degree being not less than the second specified threshold, the first image and the one or more second images that may be switched and displayed as the first multimedia content.

Determining the display form of the images in the first multimedia content based on the influence degree of cropping on the entity in the images may reduce the influence of cropping on the expressiveness of the first multimedia content, and improve the presentation effect of the first multimedia content.

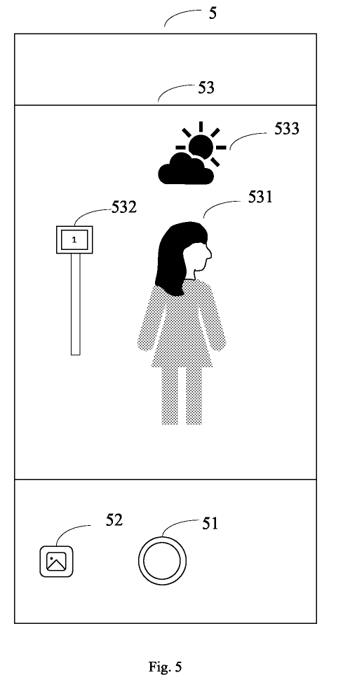

The above embodiment describes the generation of the first multimedia content with the corresponding information based on the first image of the first user. In some embodiments, after the first multimedia content is generated, content generation may also be continued based on the first multimedia content. FIG. 4 is a schematic flowchart of generating second multimedia content according to some embodiments of the present disclosure. As shown in FIG. 4, the generating the second multimedia content includes steps S41 to S45.

Similar to the generation process of the first multimedia content, when the second multimedia content is generated, a third information is first generated, one or more fourth images are generated based on the third information, and finally the second multimedia content is generated by combining the first multimedia content, a third image, and the one or more fourth images.

In step S41, a third information is generated based on a third image from a second user and the first multimedia content.

The second user may be another user other than the first user, or may be the first user. That is, any user may participate in the content generation based on the first multimedia content. For example, the second user may be invited by the first user. After receiving the first multimedia content shared by the first user, the second user determines the third image to perform further content generation based on the first multimedia content.

The manner of acquiring the third image of the second user is similar to the manner of acquiring the first image of the first user, and the third image may be acquired by the second user by capturing an image or selecting an image from an image library.

Similar to the above expansion of the first information expressed by the first image based on the entity and the background in the first image when the second information is generated, the generating the third information includes: determining an entity and a background in the third image from the second user; determining a fourth information expressed by the third image by understanding the third image; and expanding at least one of the fourth information or the second information based on the entity and the background in the third image and the entity and the background in the first multimedia content to generate the third information. The third information generated in this way is equivalent to an expansion of the second information based on the third image. The expansion here means a continuation, a supplement, an adaptation, etc.

In step S43, one or more fourth images are generated based on the third information.

Similar to the above generation of the one or more second images based on the second information, when the one or more fourth images are generated based on the third information, the number and style of the generated fourth images may be determined first, or the number of the generated fourth images may also be determined by determining the number of scenes in the third information. Details are not described herein again.

In step S45, second multimedia content is generated based on the first multimedia content, the third image, and the one or more fourth images.

When the second multimedia content is generated, the first multimedia content, the third image, and the one or more fourth images may be integrated, for example, the second multimedia content includes the first multimedia content, the third image, and the one or more fourth images. Alternatively, the first multimedia content may be adaptively modified based on the third image and the one or more fourth images, and then the second multimedia content is generated by combining the modified first multimedia content, the third image, and the one or more fourth images.

Similar to the first multimedia content, the second multimedia content may be a video or an image. In some embodiments, in order to improve the generation efficiency and the consistency between the first multimedia content and the second multimedia content, the form of the second multimedia content may be consistent with that of the first multimedia content.

After the second multimedia content is generated, content generation may also be performed again based on an image from a third user based on the actual situation. For example, the termination condition of content generation may be that the content volume of the first multimedia content reaches a first threshold, or the number of participating users reaches a second threshold, etc.

The content generation method of the present disclosure is not only capable of generating the first multimedia content with information based on the first image of the first user, but also capable of continuing content generation based on the first multimedia content, that is, generating third multimedia content by combining the third image of the second user and the first multimedia content. The content generation method of the present disclosure not only has a high richness of content generation, but also has social attributes, which may promote a plurality of users to participate in interaction, thereby promoting the usage rate of applications.

The content generation method of the present disclosure may be implemented in a specified interaction manner. That is, the first image of the first user may be acquired in response to the first user participating in the specified interaction manner. For example, the first image taken by the first user is acquired in response to the first user triggering a shooting control on a shooting interface; or the first image selected by the first user from an image library is acquired in response to the first user triggering an image selection control on the shooting interface. In the specified interaction manner, the shooting interface may be displayed to the user, to acquire the first image from the user through the shooting control or the image selection control. The shooting interface may also include other information other than the shooting control and the image selection control, such as the name and play method of the specified interaction manner. Certainly, the image selection control may also be displayed on other interfaces than the shooting interface.

The shooting interface is equivalent to an entrance for the first user to participate in the specified interaction manner. After acquiring the first image of the first user, the specified interaction manner generates the first multimedia content by implementing the content generation method of the present disclosure. In some embodiments, the first multimedia content is displayed on a preview interface in response to the generation of the first multimedia content. In this way, after participating in the specified interaction manner, the first user views the first multimedia content through the preview interface, and may subsequently save or share the first multimedia content, thereby achieving the dissemination of the first multimedia content.

When the first multimedia content is generated, the first information may first be expanded based on the entity and the background in the first image to generate the second information. Then one or more second images are generated based on the second information, and finally the first multimedia content is generated.

An application example of the present disclosure is described below with reference to FIGS. 5 to FIG. 8.

FIG. 5 is a schematic diagram of a shooting interface according to some embodiments of the present disclosure. As shown in FIG. 5, the shooting interface 5 includes a shooting control 51 and an image selection control 52, which are used to acquire a first image of a first user. At this time, the shooting interface has already acquired a first image 53 from the first user, and the first image 53 includes entities 531, 532, and a background, for example, 533 is included in the background. The first image 53 shows a girl 531 standing under a station sign 532 of bus No. 1.

By understanding the first image 53, it is determined that the first information expressed by the first image is that a person is waiting for a bus. The first information is expanded based on the entities in the first image 53, that is, the girl 531 and the station sign 532, and 533 in the background indicating that the weather is sunny, to generate a second information. For example, the expansion information of the station sign 532 is a bus. The expansion information of the girl 531 may be that the girl 531 is listening to music. The expansion information of 533 in the background may be a vibrant flower bed by the road. In addition, in combination with the background and the first information, the emotion included in the first image 53 may be happy.

In this way, the first information is expanded in combination with the expansion information and the emotion to generate the second information. The second information is, for example, that the girl is waiting for a bus, and after a while, the girl gets on the bus after waiting for the bus. In the process of the bus driving, the girl took a picture of a flower bed on the roadside and wanted to share it with her friend.

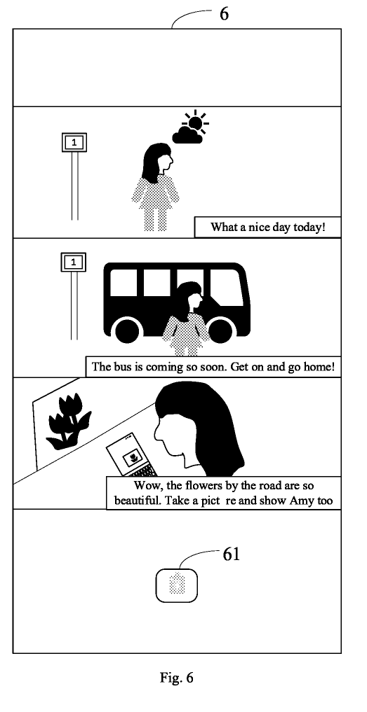

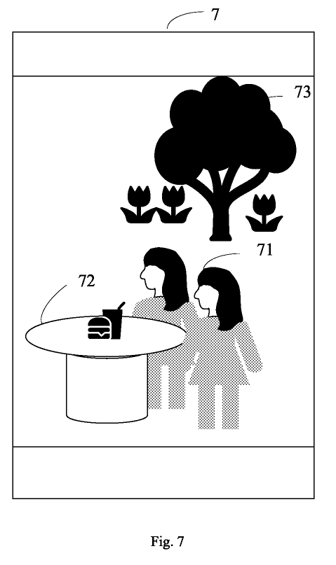

Based on the second information, a plurality of second images are generated, and finally the first multimedia content is generated. FIG. 6 is a schematic diagram of first multimedia content according to some embodiments of the present disclosure. As shown in FIG. 6, the first multimedia content includes an image formed by concatenating a plurality of images, and a subtitle is displayed on each image.

As shown in FIG. 6, an expansion control 61 may also be included on an interface 6 that displays the first multimedia content, which is used to acquire a third image of a second user and generate second multimedia content based on the third image and the first multimedia content.

After triggering the expansion control 61, the second user may determine the third image by taking a picture or selecting an image from an image library. FIG. 7 is a schematic diagram of a third image according to some embodiments of the present disclosure. As shown in FIG. 7, the third image in an interface 7 shows an outdoor scene, including entities 71, 72, and a background, for example, 73 is included in the background. The first image 73 shows two girls 71 preparing to have a picnic at a table 72 under a tree 73.

Similar to the generation of the second information, a third information is generated based on the entity and the background in the third image and the entity and the background in the first multimedia content. The third information is, for example, that a girl is waiting for a bus, and after a while, the girl gets on the bus after waiting for the bus. In the process of the bus driving, the girl took a picture of a flower bed on the roadside and wanted to share it with her friend. After receiving the message, the friend proposed to go on a picnic outside. So the two girls found a place for a picnic and spent a happy time.

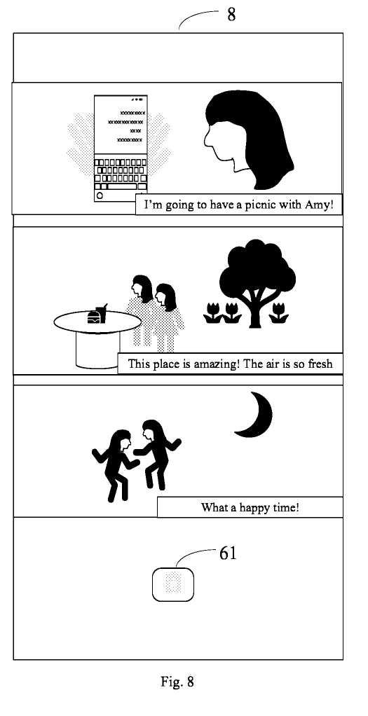

FIG. 8 is a schematic diagram of second multimedia content according to some embodiments of the present disclosure. The second multimedia content generated based on the third image and the first multimedia content includes an image formed by concatenating a plurality of images, and a subtitle is displayed on each image. FIG. 8 shows only some examples of the second multimedia content. The complete second multimedia content may include the content shown in FIGS. 6 and FIG. 8. In addition, the interface that displays the second multimedia content may also include the expansion control 61 for performing content generation again based on the second multimedia content.

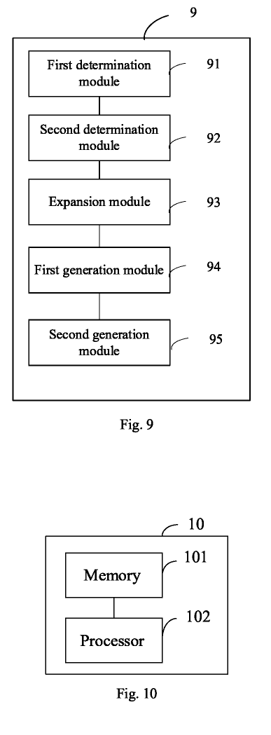

FIG. 9 is a schematic structural diagram of a content generation apparatus according to some embodiments of the present disclosure. As shown in FIG. 9, the content generation apparatus 9 includes modules 91 to 95.

A first determination module 91, configured to determine an entity and a background in a first image from a first user.

A second determination module 92, configured to determine first information expressed by the first image by understanding the first image.

An expansion module 93, configured to expand the first information based on the entity and the background in the first image to generate second information.

A first generation module 94, configured to generate one or more second images based on the second information.

A second generation module 95, configured to generate first multimedia content based on the first image and the one or more second images.

In some embodiments, the expansion module 93 is configured to determine expansion information based on the entity and the background in the first image and the first information, the expansion information being configured to represent at least one of: change information of the entity and the background in the first image, or association information of the entity and the background in the first image; and expand the first information through the expansion information to generate the second information.

In some embodiments, the expansion module 93 is configured to determine an emotion included in the first image based on the entity and the background in the first image; and expand the first information based on the emotion included in the first image and the entity and the background in the first image to generate the second information.

In some embodiments, the expansion module 93 is configured to determine the change information of the entity and the background in the first image based on the emotion; and expand the first information based on the emotion and the change information of the entity and the background in the first image to generate the second information.

In some embodiments, the expansion module 93 is configured to: determine, in response to the entity in the first image including a character, change information of at least one of an action or an expression of the character based on the emotion; or determine, in response to the entity in the first image including an object, change information of a form of the object based on the emotion; or determine change information of at least one of an environment or an atmosphere of the background in the first image based on the emotion.

In some embodiments, the expansion module 93 is configured to determine the association information of the entity and the background in the first image based on the emotion; and expand the first information based on the emotion and the association information of the entity and the background in the first image to generate the second information.

In some embodiments, the first generation module 94 is configured to determine one or more scenes and information corresponding to each of the one or more scenes based on the second information; and generate, for the information corresponding to each scene, a second image corresponding to the scene.

In some embodiments, the first generation module 94 is configured to determine a style of the one or more second images based on an emotion included in at least one of the second information or the first image; and generate the one or more second images based on the style of the one or more second images.

In some embodiments, the second generation module 95 is configured to determine a subtitle of each image of the first image and the one or more second images, the subtitle of the each image being generated based on the information corresponding to the each image; and generate the first multimedia content based on the first image and the one or more second images, each image in the first multimedia content having a subtitle.

In some embodiments, the first multimedia content is an image, where the first multimedia content includes a plurality of images that may be switched and displayed, or an image formed by concatenating the plurality of images; or the first multimedia content is a video.

In some embodiments, the first multimedia content is a video in response to the emotional intensity of the second information being greater than a first specified threshold; and the first multimedia content is an image in response to the emotional intensity of the second information being not greater than the first specified threshold.

In some embodiments, the first multimedia content includes an image formed by concatenating the plurality of images in response to the image ratio of the first image and the one or more second images being within a specified range.

In some embodiments, the second generation module 95 is configured to determine the influence degree of a specified cropping ratio on the entity in each of the first image and the one or more second images; determine, in response to the influence degree being less than a second specified threshold, an image formed by concatenating the first image and the one or more second images as the first multimedia content; and determine, in response to the influence degree being not less than the second specified threshold, the first image and the one or more second images that may be switched and displayed as the first multimedia content.

In some embodiments, the content generation apparatus 9 is further configured to: acquire the first image taken by the first user in response to the first user triggering a shooting control on a shooting interface; or acquire the first image selected by the first user from an image library in response to the first user triggering an image selection control on the shooting interface.

In some embodiments, the content generation apparatus 9 is further configured to display the first multimedia content on a preview interface in response to the generation of the first multimedia content.

In some embodiments, the content generation apparatus 9 is further configured to generate a third information based on a third image from a second user and the first multimedia content; generate one or more fourth images based on the third information; and generate second multimedia content based on the first multimedia content, the third image, and the one or more fourth images.

In some embodiments, the content generation apparatus 9 is further configured to determine an entity and a background in the third image from the second user; determine a fourth information expressed by the third image by understanding the third image; and expand at least one of the fourth information or the second information based on the entity and the background in the third image and the entity and the background in the first multimedia content to generate the third information.

In the above embodiment, the first multimedia content with the corresponding information may be automatically generated based on the first image of the first user. This content generation method is capable of automatically generating information based on an image and then automatically generating multimedia content based on the information. Therefore, this content generation method is more intelligent, and the generated content is richer in content, which helps to improve the enthusiasm of user interaction, thereby improving the usage rate of applications.

FIG. 10 is a block diagram of an electronic device according to some embodiments of the present disclosure. As shown in FIG. 10, the electronic device 10 includes a memory 101; and a processor 102 coupled to the memory 101, the processor 102 configured to, based on instructions stored in the memory 101, carry out the method in any of the previous embodiments. In this way, the first multimedia content with the corresponding information may be automatically generated based on the first image of the first user. This content generation method is capable of automatically generating information based on an image and then automatically generating multimedia content based on the information. Therefore, this content generation method is more intelligent, and the generated content is richer in content, which helps to improve the enthusiasm of user interaction, thereby improving the usage rate of applications.

The memory 101 is used to store one or more computer-readable instructions. The memory 101 may include any combination of various forms of computer-readable storage media, such as volatile memory and/or non-volatile memory, including but not limited to random access memory (RAM), dynamic random access memory (DRAM), static random access memory (SRAM), read-only memory (ROM), and flash memory. For example, the memory 101 may store an operating system, an application, a boot loader, a database, and other programs, and may also store various applications, various data, and the like.

The processor 102 is used to run the computer-readable instructions to implement the method described in any of the previous embodiments. For the specific implementation of each step of the method, reference may be made to the above embodiments, and details of the same parts are not repeated here.

The processor 102 may be configured to execute the steps in FIGS. 1 to FIG. 8. The processor 102 may be embodied as various processing apparatuses, such as a central processing unit (CPU) and a network processor (NP); and may also be a digital signal processor (DSP), an application specific integrated circuit (ASIC), a field programmable gate array (FPGA) or other programmable logic devices, a discrete gate or transistor logic device, and a discrete hardware component. The central processing unit (CPU) may have an X86 or ARM architecture or the like.

The processor 102 and the memory 101 may directly or indirectly communicate with each other. For example, the processor 102 and the memory 101 may communicate through a network. The network may include a wireless network, a wired network, and/or any combination of a wireless network and a wired network. The processor 102 and the memory 101 may also communicate with each other through a system bus, which is not limited in the present disclosure.

It should be noted that the components of the electronic device 10 shown in FIG. 10 are only exemplary and non-restrictive, and the electronic device 10 may have other components according to actual application needs. The processor 102 may control other components in the electronic device 10 to perform desired functions.

The electronic device 10 may be implemented by software, firmware, and/or hardware, and may be integrated in an apparatus installed with related applications.

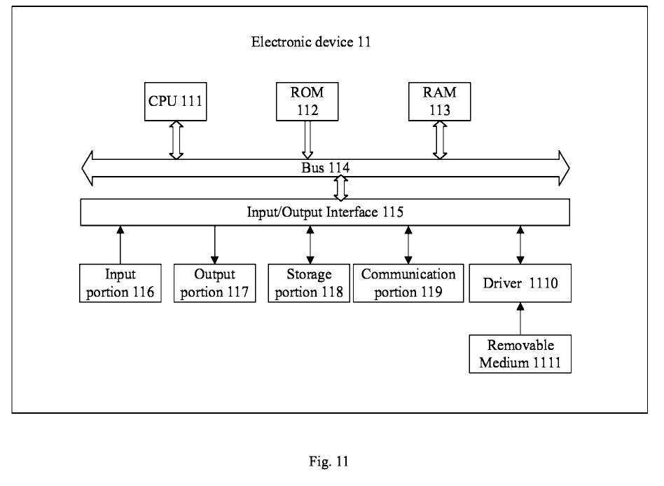

FIG. 11 is a block diagram of an electronic device according to other embodiments of the present disclosure.

The electronic device 11 shown in FIG. 11 may be a computer system having a dedicated hardware structure, and may perform corresponding functions when installed with related applications.

The electronic device includes, but is not limited to, a mobile terminal such as a smartphone, a notebook computer, a personal digital assistant (PDA), a tablet personal computer (Tablet PC), a portable multimedia player (PMP), and an in-vehicle terminal (e.g., an in-vehicle navigation terminal), a wearable device, etc., and a stationary terminal such as a digital television, a desktop computer, etc.

As shown in FIG. 11, a central processing unit (CPU) 111 executes various processes based on a program stored in a read-only memory (ROM) 112 or a program loaded from a storage unit 118 into a random access memory (RAM) 113. The RAM 113 stores data required when the CPU 111 executes various processes, as needed. The central processing unit is merely exemplary, and it may be other types of processors, such as the various processors described above. The ROM 112, the RAM 113, and the storage unit 118 may be various forms of computer-readable storage media. It should be noted that although the ROM 112, the RAM 113, and the storage unit 118 are separately shown in FIG. 11, one or more of them may be combined or located in the same or different memories or storage modules.

The CPU 111, the ROM 112, and the RAM 113 are connected to each other via a bus 114. An input/output interface 115 is also connected to the bus 114.

The following components are connected to the input/output interface 115: an input unit 116, such as a touch screen, a touchpad, a keyboard, a mouse, an image sensor, a microphone, an accelerometer, and a gyroscope; an output unit 117, including a display, such as a cathode ray tube (CRT) and a liquid crystal display (LCD), a speaker, and a vibrator; the storage unit 118, including a hard disk and a magnetic tape; and a communication unit 119, including a network interface card, such as a LAN card and a modem. The communication unit 119 allows communication processing to be performed via a network such as the Internet. It is easy to understand that although the components in the electronic device 11 are shown in FIG. 11 to communicate through the bus 114, they may also communicate through a network or other means, where the network may include a wireless network, a wired network, and/or any combination of a wireless network and a wired network.

A driver 1110 is also connected to the input/output interface 115 as needed. A removable medium 1111, such as a magnetic disk, an optical disc, a magneto-optical disc, and a semiconductor memory, is installed in the driver 1110 as needed, so that a computer program read therefrom is installed in the storage unit 118 as needed.

In the case where the above series of processes are implemented by software, a program constituting the software may be installed from a network such as the Internet or a storage medium such as the removable medium 1111.

According to the embodiments of the present disclosure, the process described above with reference to the flowchart may be implemented as a computer software program. For example, some embodiments of the present disclosure include a computer program product, which, when running on a computer, causes the computer to implement the method described in any of the previous embodiments. In this way, the first multimedia content with the corresponding information may be automatically generated based on the first image of the first user. This content generation method is capable of automatically generating information based on an image and then automatically generating multimedia content based on the information. Therefore, this content generation method is more intelligent, and the generated content is richer in content, which helps to improve the enthusiasm of user interaction, thereby improving the usage rate of applications. The computer program product includes computer instructions carried on a computer-readable medium, including program code for carrying out the method shown in the flowchart. In such an embodiment, the computer instructions may be downloaded and installed from a network via the communication unit 119, or installed from the storage unit 118, or installed from the ROM 112. When the computer program is executed by the CPU 111, the method of the embodiments of the present disclosure is executed.

It should be noted that in the context of the present disclosure, the computer-readable medium may be a tangible medium that may contain or store a program for use by or in combination with an instruction execution system, apparatus, or device.

The computer-readable medium may be a computer-readable storage medium, a computer-readable signal medium, or any combination thereof.

The computer-readable storage medium includes, but is not limited to, an electrical, magnetic, optical, electromagnetic, infrared, or semiconductor system, apparatus, or device, or any suitable combination thereof. More specific examples of the computer-readable storage medium may include, but are not limited to, an electrical connection having one or more wires, a portable computer magnetic disk, a hard disk, a random access memory (RAM), a read-only memory (ROM), an erasable programmable read-only memory (EPROM or flash memory), an optical fiber, a portable compact disc read-only memory (CD-ROM), an optical storage device, a magnetic storage device, or any suitable combination thereof. In the present disclosure, the computer-readable storage medium may be any tangible medium that contains or stores a program, which may be used by or in combination with an instruction execution system, apparatus, or device. The computer-readable storage medium has computer instructions stored thereon, which, when executed by a processor, implement the method described in any of the previous embodiments. In this way, the first multimedia content with the corresponding information may be automatically generated based on the first image of the first user. This content generation method is capable of automatically generating information based on an image and then automatically generating multimedia content based on the information. Therefore, this content generation method is more intelligent, and the generated content is richer in content, which helps to improve the enthusiasm of user interaction, thereby improving the usage rate of applications.

The computer-readable signal medium may include a data signal propagated on a baseband or as a part of a carrier, and computer-readable program code is carried therein. This propagated data signal may be in multiple forms, and includes, but is not limited to, an electromagnetic signal, an optical signal, or any suitable combination thereof. The computer-readable signal medium may also be any computer-readable medium other than the computer-readable storage medium, and the computer-readable signal medium may send, disseminate, or transmit the program used by or in combination with the instruction execution system, apparatus, or device. The program code contained on the computer-readable medium may be transmitted in any suitable medium, including, but not limited to, a wire, an optical cable, a radio frequency (RF), or any suitable combination thereof.

The above computer-readable medium may be included in the above electronic device, or may exist alone without being assembled into the electronic device.

In some embodiments, there is further provided a computer program, including: instructions that, when executed by a processor, cause the processor to carry out the method described in any of the previous embodiments. For example, the instructions may be embodied as computer program code.

In the embodiments of the present disclosure, the computer program code for performing the operations of the present disclosure may be written in one or more programming languages or a combination thereof, where the programming languages include, but are not limited to, object-oriented programming languages, such as Java, Smalltalk, and C++, and include conventional procedural programming languages, such as "C" language or similar programming languages. The program code may be executed entirely on a user computer, partly on a user computer, as a stand-alone software package, partly on a user computer and partly on a remote computer, or entirely on a remote computer or server. In the case of involving a remote computer, the remote computer may be connected to the user computer through any kind of network, including a local area network (LAN) or a wide area network (WAN), or may be connected to an external computer (for example, connected by using Internet provided by an Internet service provider).

The flowcharts and block diagrams in the drawings illustrate the possibly implemented architectures, functions, and operations of the system, the method, and the computer program product according to various embodiments of the present disclosure. In this regard, each block in the flowchart or block diagram may represent a module, program segment, or part of code, which contains one or more executable instructions for implementing the specified logical functions. It should also be noted that, in some alternative implementations, the functions marked in the blocks may also occur in an order different from that marked in the drawings. For example, two blocks shown in succession may actually be executed substantially in parallel, or they may sometimes be executed in the reverse order, depending on the functions involved. It should also be noted that each block in the block diagram and/or the flowchart, and a combination of the blocks in the block diagram and/or the flowchart may be implemented by a dedicated hardware-based system that executes specified functions or operations, or may be implemented by a combination of dedicated hardware and computer instructions.

The functions described above may be performed at least in part by one or more hardware logic components. For example, without limitation, exemplary hardware logic components that may be used include: a field programmable gate array (FPGA), an application specific integrated circuit (ASIC), an application specific standard product (ASSP), a system on chip (SOC), a complex programmable logical device (CPLD), and the like.

Although some specific embodiments of the present disclosure have been described in detail by way of examples, those skilled in the art should understand that the above examples are only for illustration, and are not intended to limit the scope of the present disclosure. Those skilled in the art should understand that the above embodiments may be modified without departing from the scope and spirit of the present disclosure. The scope of the present disclosure is defined by the appended claims.

1. A content generation method, comprising:
determining an entity and a background in a first image from a first user;
determining first information expressed by the first image by understanding the first image; expanding the first information based on the entity and the background in the first image to generate
second information;
generating one or more second images based on the second information; and
generating first multimedia content based on the first image and the one or more second images.

2. The content generation method of claim 1, wherein expanding the first information based on the entity and the background in the first image to generate the second information comprises:
determining expansion information based on the entity and the background in the first image and the first information, wherein the expansion information is configured to represent at least one of: change information of the entity and the background in the first image, or association information of the entity and the background in the first image; and
expanding the first information through the expansion information to generate the second information.

3. The content generation method of claim 1, wherein expanding the first information based on the entity and the background in the first image to generate the second information comprises:
determining an emotion conveyed by the first image based on the entity and the background in the first image; and
expanding the first information based on the emotion conveyed by the first image and the entity and the background in the first image to generate the second information.

4. The content generation method of claim 3, wherein expanding the first information based on the emotion conveyed by the first image and the entity and the background in the first image to generate the second information comprises:
determining change information of the entity and the background in the first image based on the emotion;
and
expanding the first information based on the emotion and the change information of the entity and the
background in the first image to generate the second information.

5. The content generation method of claim 4, wherein determining the change information of the entity and the background in the first image based on the emotion comprises:
determining, in response to the entity in the first image comprising a character, change information of at least one of an action or an expression of the character based on the emotion; or
determining, in response to the entity in the first image comprising an object, change information of a form of the object based on the emotion; or
determining change information of at least one of an environment or an atmosphere of the background in the first image based on the emotion.

6. The content generation method of claim 3, wherein expanding the first information based on the emotion conveyed by the first image and the entity and the background in the first image to generate the second information comprises:
determining association information of the entity and the background in the first image based on the emotion; and
expanding the first information based on the emotion and the association information of the entity and the background in the first image to generate the second information.

7. The content generation method of claim 1, wherein generating the one or more second images based on the second information comprises:
determining one or more scenes and information corresponding to each of the one or more scenes based on the second information; and
generating, for the information corresponding to the each scene, a second image corresponding to the scene.

8. The content generation method of claim 1, wherein generating the one or more second images based on the second information comprises:
determining a style of the one or more second images based on an emotion conveyed by at least one of the second information or the first image; and
generating the one or more second images based on the style of the one or more second images.

9. The content generation method of claim 1, wherein generating the first multimedia content based on the first image and the one or more second images comprises:
determining a subtitle of each image of the first image and the one or more second images, wherein the subtitle of the each image is generated based on the information corresponding to the each image; and
generating the first multimedia content based on the first image and the one or more second images, wherein each image in the first multimedia content has a subtitle.

10. The content generation method of claim 1, wherein:
the first multimedia content is an image, wherein the first multimedia content comprises a plurality of images that are switchable for display, or an image formed by concatenating the plurality of images; or
the first multimedia content is a video.

11. The content generation method of claim 10, wherein:
the first multimedia content is a video in response to an emotional intensity of the second information being greater than a first specified threshold; and
the first multimedia content is an image in response to the emotional intensity of the second information being not greater than the first specified threshold.

12. The content generation method of claim 10, wherein:
the first multimedia content comprises an image formed by concatenating the plurality of images in response to image ratios of the first image and the one or more second images being within a specified range.

13. The content generation method of claim 10, wherein generating the first multimedia content based on the first image and the one or more second images comprises:
determining an influence degree of a specified cropping ratio on an entity in each of the first image and the one or more second images;
determining, in response to the influence degree being less than a second specified threshold, an image formed by concatenating the first image and the one or more second images as the first multimedia content; and
determining, in response to the influence degree being not less than the second specified threshold, the first image and the one or more second images that are switchable for display as the first multimedia content.

14. The content generation method of claim 1, further comprising:
acquiring the first image taken by the first user in response to the first user triggering a shooting control on a shooting interface; or
acquiring the first image selected by the first user from an image library in response to the first user triggering an image selection control on the shooting interface.

15. The content generation method of claim 1, further comprising:
displaying the first multimedia content on a preview interface in response to the generation of the first multimedia content.

16. The content generation method of claim 1, further comprising:
generating a third information based on a third image from a second user and the first multimedia content; generating one or more fourth images based on the third information; and
generating second multimedia content based on the first multimedia content, the third image, and the one or more fourth images.

17. The content generation method of claim 16, wherein generating the third information based on the third image from the second user and the first multimedia content comprises:
determining an entity and a background in the third image from the second user;
determining a fourth information expressed by the third image by understanding the third image; expanding at least one of the fourth information or the second information based on the entity and the
background in the third image and the entity and the background in the first multimedia content to generate the
third information.

18. An electronic device, comprising:
at least one memory; and
at least one processor coupled to the at least one memory, the at least one processor configured to, based on instructions stored in the at least one memory, carry out a content generation method comprising:
determining an entity and a background in a first image from a first user;
determining first information expressed by the first image by understanding the first image; expanding the first information based on the entity and the background in the first image to generate
second information;
generating one or more second images based on the second information; and
generating first multimedia content based on the first image and the one or more second images.

19. The electronic device of claim 18, wherein the expanding the first information based on the entity and the background in the first image to generate the second information comprises:
determining expansion information based on the entity and the background in the first image and the first information, wherein the expansion information is configured to represent at least one of: change information of the entity and the background in the first image, or association information of the entity and the background in the first image; and
expanding the first information through the expansion information to generate the second information.

20. A non-transitory computer-readable storage medium, having a computer program stored thereon, which, when executed by a processor, causes the processor to implement a content generation method comprising:
determining an entity and a background in a first image from a first user;
determining first information expressed by the first image by understanding the first image; expanding the first information based on the entity and the background in the first image to generate
second information;
generating one or more second images based on the second information; and
generating first multimedia content based on the first image and the one or more second images.
